(19) United States
(12) Patent Application Publication
(10) Pub. No.: US 2012/0065333 A1
(43) Pub. Date: Mar. 15, 2012

(54) CROSSLINKABLE HIGH MELT STRENGTH POLYPROPYLENE RESINS

(75) Inventors: Fengkui Li, Houston, TX (US); John Ashbaugh, Houston, TX (US)

(73) Assignee: Fina Technology, Inc., Houston, TX (US)

(21) Appl. No.: 12/882,274

(22) Filed: Sep. 15, 2010

(51) Int. Cl. C08L 51/00

(52) U.S. Cl. 525/106

(57) ABSTRACT

Crosslinkable silane-grafted polypropylene compositions and processes of forming the same are described herein. The processes generally include contacting a polyolefin, a multifunctional monomer and a silane compound in the presence of a radical initiator, wherein the polyolefin is selected from polypropylene, polyethylene, combinations thereof and copolymers thereof.

### FIELD

Embodiments of the present invention generally relate to high melt strength crosslinkable polypropylene resin compositions. In particular, embodiments of the invention relate to silane-grafted polypropylene resin compositions.

### BACKGROUND

As reflected in the patent literature, vinylsilane has been utilized for the formation of crosslinkable or crosslinked polyolefins such as polyethylene and polypropylene. Vinylsilane (CH₂═CH—SiH₃) is typically grafted onto polyolefin in the presence of peroxide in order to form free radical sites along the polyolefin chain for grafting vinylsilane. The vinyl group (—CH═CH₂) of vinylsilane reacts with the polyolefin free-radical sites to form silane-grafted polyolefin. This method is commonly used to form silane-grafted polyethylene. Grafting vinylsilane onto polypropylene often includes the addition of heat in a similar method referred to as melt grafting. In other words, vinylsilane is melt grafted at free radical sites along the polypropylene chain in the presence of peroxide to form silane-grafted polypropylene. The resultant silane pendant groups may be crosslinked by exposure to hot water or steam to form long-chain branching or crosslinked polypropylene.

However, one common drawback of these methods to form silane-grafted polyproylene is extensive polymer chain scission, often referred to as a vis-breaking (viscosity breaking), that is concomitantly promoted by the generation of free radicals primarily through the use of peroxide during grafting and to a lesser degree by exposure to heat during melt grafting. As a result, upon stem crosslinking, the crosslinked polypropylene structure is not as extensively crosslinked (per chain) due to the crosslinking of lower molecular weight polypropylene chains. The crosslinked polypropylene structure having a lower crosslink density per chain undesirably exhibits lower strength and creep resistence. Alternatively, when long-chain branching is introduced purposely by stem crosslinking, the low molecular weight polypropylene species resulting from extensive vis-breaking can have detrimental effect on the desired high melt strength.

Therefore, a need exists to provide a method of producing silane-grafted polypropylene resin compositions while minimizing vis-breaking and providing higher molecular weight compositions that may be steam crosslinked to form long-chain branching and/or crosslinked polypropylene structures exhibiting superior melt processing and physical properties.

### SUMMARY

Embodiments of the present invention include processes for forming crosslinkable silane-grafted polypropylene compositions. The process generally includes contacting a polyolefin, a multifunctional monomer and a silane compound in the presence of a radical initiator, wherein the polyolefin is selected from polypropylene, polyethylene, combinations thereof and copolymers thereof.

One or more embodiments include the process of the preceding paragraph, wherein the polyolefin is selected from polypropylene homopolymer, polypropylene based random copolymer, and a polypropylene impact copolymer.

One or more embodiments include the process of any preceding paragraph, wherein the multifunctional monomer is selected from difunctional monomers, trifunctional monomers and combinations thereof.

One or more embodiments include the process of any preceding paragraph, wherein the multifunctional monomer is either hydrophobic or hydrophilic.

One or more embodiments include the process of any preceding paragraph, wherein the multifunctional monomer is an acrylic monomer.

One or more embodiments include the process of any preceding paragraph, wherein the multifunctional monomer is selected from diethylene glycol diacrylate, tridecylacrylate hexanediol diacrylate, 1,6-hexanediol diacrylate, trimethylolpropane triacrylate, polyethylene glycol diacrylate, neopentane diol diacrylate, polyethylene glycol diacrylate, ethoxylated trimethylolpropane triacrylate, trimethylpropane triacrylate (TMPTA) esters, propoxylated neopentyl glycol diacrylate, alkoxylated hexanediol diacrylate, tris (2-hydroxy ethyl) isocyanurate triacrylate, and combinations thereof.

One or more embodiments include the process of any preceding paragraph, wherein the multifunctional monomer contacts the polyolefin in a concentration of from about 0.1 wt. % to about 20 wt. %.

One or more embodiments include the process of any preceding paragraph, wherein the silane compound is vinylsilane, a vinylsilane derivative, or combination thereof.

One or more embodiments include the process of any preceding paragraph, wherein the silane compound is a vinyl alkoxysilane compound having a general chemical structure of CH₂═CH—Si(OR)₃, wherein R is any alkyl group of 1 to 4 carbons.

One or more embodiments include the process of any preceding paragraph, wherein the silane compound is selected from vinyltrimethoxysilane, vinyltriethoxysilane, vinylmethoxyethoxysilane, and combinations thereof.

One or more embodiments include the process of any preceding paragraph, wherein the silane compound contacts the polyolefin in a concentration of from about 0.1 wt. % to about 20 wt. %.

One or more embodiments include the process of any preceding paragraph, wherein the radical initiator is a peroxide.

One or more embodiments include the process of any preceding paragraph, wherein the contacting comprises blending the polyolefin, the multifunctional monomer, the silane compound, and the radical initiator in a single step.

One or more embodiments include the process of any preceding paragraph, wherein the crosslinkable silane-grafted polyolefin composition is capable of forming a crosslinked or long-chain branched product by forming the composition into an article and exposing the article to moisture.

One or more embodiments include the process of any preceding paragraph, wherein the crosslinkable silane-grafted polyolefin composition is a coupling agent capable of adhering to glass.

One or more embodiments include a crosslinkable silane-grafted polyolefin composition formed by the process of any preceding paragraph.

### DETAILED DESCRIPTION

### Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some eases refer to certain specific embodiments only. In other cases it will be recognized that references to the “invention” will refer to subject matter recited in one or more, but not necessarily all, of the claims. Bach of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition skilled persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Further, any ranges include iterative ranges or like magnitude fallings within the expressly stated ranges or limitations.

Embodiments of the present invention provide crosslinkable and/or long chain branching polyolefin compositions formed by grafting silane compounds to polyolefin in the presence of a multifunctional monomer and a radical initiator. The multifunctional monomer participates in the reactions by caputuring the polypropylene tertiary free radicals, minimizing beta-scission (vis-breaking). The multifunctional monomer may also participate in grafting reaction to bridge the silane compound of the polyolefin.

### Catalyst Systems

Catalyst systems useful for polymerizing olefin monomers include any suitable catalyst system. For example, the catalyst system may include chromium based catalyst systems, single site transition metal catalyst systems including metallocene catalyst systems, Ziegler-Natta catalyst systems or combinations thereof, for example. The catalysts may be activated for subsequent polymerization and may or may not be associated with a support material, for example. A brief discussion of such catalyst systems is included below, but is in no way intended to limit the scope of the invention to such catalysts.

For example, Ziegler-Natta catalyst systems are generally formed from the combination of a metal component (e.g., a catalyst) with one or more additional components, such a catalyst support, a cocatalyst and/or one or more electron donors, for example.

Metallocene catalysts may be characterized generally as coordination compounds incorporating one or more cyclopentadienyl (Cp) groups (which may be substituted or unsubstituted, each substitution being the same or different) coordinated with a transition metal through π bonding. The substituent groups on Cp may he linear, branched or cyclic hydrocarbyl radicals, for example. The cyclic hydrocarbyl radicals may further form other contiguous ring structures, including indenyl, azulenyl and fluroenyl groups, for example. These contiguous ring structures may also be substituted or unsubstituted by hydrocarbyl radicals, such as C₁ to C₂₀ hydrocarbyl radicals, for example.

### Polymerization Processes

As indicated elsewhere herein, catalyst systems are used to form, polyolefin compositions. Once the catalyst system is prepared, as described above and/or as known to one skilled in the art, a variety of processes may be carried out using that composition. The equipment, process conditions, reactants, additives and other materials used in polymerization processes wall vary in a given process, depending on. the desired composition and properties of the polymer being formed. Such processes may include solution phase, gas phase, slurry phase, bulk phase, high pressure processes or combinations thereof, for example, (See, U.S. Pat. No. 5,525,678; U.S. Pat. No. 6,420,580; U.S. Pat. No. 6,380,328: U.S. Pat. No. 6,359,072; U.S. Pat. No. 6,346,586; U.S. Pat. No. 6,340,730; U.S. Pat. No. 6,339,134; U.S. Pat. No. 6,300,436: U.S. Pat. No. 6,274,684; U.S. Pat. No. 6,271,323; U.S. Pat. No. 6,248,845; U.S. Pat. No. 6,245,868; U.S. Pat. No. 6,245,705; U.S. Pat. No. 6,242,545; U.S. Pat. No. 6,211,105; U.S. Pat. No. 6,207,606; U.S. Pat. No. 6,180,735 and U.S. Pat. No. 6,147,173, which are incorporated by reference herein.)

In certain embodiments, the processes described above generally include polymerizing one or more olefin monomers to form polymers. The olefin monomers may include C₂ to C₃₀ olefin monomers, or C₂ to C₁₂ olefin monomers (e.g., ethylene, propylene, butene, pentene, 4-metyl-1-pentene, hexene, octene and decene), for example. The monomers may include olefinic unsaturated monomers, C₄ to C₁₈ diolefins, conjugated or nonconjugated dienes, polyenes, vinyl monomers and cyclic olefins, for example. Non-limiting examples of other monomers may include norbornene, norbornadiene, isobutylene, isoprene, vinylbenzycyclobutane, styrene, alkyl substituted styrene, ethylidene norbornene, dicyclopentadiene and cyclopentene, for example. The formed polymer may include homopolymera, copolymers or terpolymers, for example.

Examples of solution processes are described in U.S. Pat. No. 4,271,060, U.S. Pat. No. 5,901,205, U.S. Pat. No. 5,236,998 and U.S. Pat. No. 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may he added to replace the polymerized monomer. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about 120° C. or from about 60° C. to about 115° C., or from about 70° C. to about 110° C. or from about 70° C. to about 95° C., for example. (See, for example, U.S. Pat. No. 4,543,399; U.S. Pat. No. 4,588,790; U.S. Pat. No. 5,228,670; U.S. Pat. No. 5,317,036; U.S. Pat. No. 5,352,749; U.S. Pat. No. 5,405,922; U.S. Pat. No. 5,436,304; U.S. Pat. No. 5,456,471; U.S. Pat. No. 5,462,999; U.S. Pat. No. 5,616,661; U.S. Pat. No. 5,627,242; U.S. Pat. No. 5,665,818; U.S. Pat. No. 5,677,375 and U.S. Pat. No. 5,668,228, which are incorporated by reference herein.)

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutene), for example. The medium employed is generally liquid under the conditions of polymerization and relatively inert. A bulk phase process is similar to that of a slurry process with the exception that the liquid medium is also the reactant (e.g., monomer) in a bulk phase process. However, a process may be a bulk process, a slurry process or a bulk slurry process, for example.

In a specific embodiment, a slurry process or a bulk process may be earned out continuously in one or more loop reactors. The catalyst, as slurry or as a dry free flowing powder, may be injected regularly to the reactor loop, which can itself be filled with circulating slurry of growing polymer particles in a diluent, for example. Optionally, hydrogen (or other chain terminating agents, for example) may be added to the process, such as for molecular weight control of the resultant polymer. The loop reactor may be maintained at a pressure of from about 27 bar to about 50 bar or from about 35 bar to about 45 bar and a temperature of from about 38° C. to about 121° C., for example, Reaction heat may be removed through the loop wall via any suitable method, such as via a double-jacketed pipe or heat exchanger, for example.

Alternatively, other types of polymerization processes may be used, such as stirred reactors in series, parallel or combinations thereof, for example. Upon removal from the reactor, the polymer may be passed to a polymer recovery system for further processing, such as addition of additives and/or extrusion, for example.

### Polymer Product

The polyolefins (and blends thereof) formed via the processes described herein may include, but are not limited to, primarily polypropylene homopolymers and polypropylene copolymers, elastomers, and plastomers, for example.

Unless otherwise designated herein, all testing methods are the current methods at the time of filing.

In one or more embodiments, the polyolefins include propylene based polymers. As used herein, the term “propylene based” is used interchangeably with, the terms “propylene polymer” or “polypropylene” and refers to a polymer having at least about 50 wt. %, or at least about 70 wt. %, or at least about 75 wt. %, or at least about 80 wt. %, or at least about 85 wt. % or at least about 90 wt. % polypropylene relative to the total weight of polymer, for example.

In one embodiment, propylene based polymers may have a molecular weight (M_{w}) of at least about 160,000 (as measured by gel permeation chromatography), for example.

The propylene based polymers may have a melt flow rate (MFR) (as measured by ASTM D-1238) of from about 0.01 dg/min to about 2000 dg/min., or from about 0.01 dg/min. to about 100 dg/min., for example. In one or more embodiments, the propylene based polymers have a low melt flow rate. As used herein, the term low melt flow rate refers to a polymer having a MFR of less than about 10 dg/min., or less than, about 6 dg/min., or less than about 2.6 dg/min., or from about 0.5 dg/min. to less than 10 dg/min. or from about 0.5 dg/min. to about 6 dg/min., for example.

In one or more embodiments, the polyolefins include polypropylene homopolymers. Unless otherwise specified, the term “polypropylene homopolymer” refers to propylene homopolymers, i.e., polypropylene, or those polyolefins composed primarily of propylene and amounts of other comonomers, wherein the amount of comonomer is insufficient to change the crystalline nature of the propylene polymer significantly.

In one or more embodiments, the polyolefins include polypropylene based random copolymers. Unless otherwise specified, the term “propylene based random copolymer” refers to those copolymers composed primarily of propylene and an amount of at least one comonomer, wherein the polymer includes at least about 0.3 wt. %, or at least about 0.8 wt. %, or at least about 2 wt. %, or from about 0.5 wt. % to about 5.0 wt. %, or from about 0.6 wt. % to about 1.0 wt. % comonomer relative to the total weight of polymer, for example. The comonomers may be selected from C₂ to C₁₆ alkenes. For example, the comonomers may be selected from ethylene, propylene, 1-butene, 1-pentene, 1-hexene, 1-heptene, 1-octene, 1-nonene, 1-decene, 4-methyl-1-pentene and combinations thereof. In one specific embodiment, the comonomer includes ethylene. Further, the term “random copolymer” refers to a copolymer formed of macromolecules in which the probability of finding a given monomeric unit at any given site in the chain is independent of the nature of the adjacent units.

In one or more embodiments, the polyolefins include polypropylene impact copolymers. Unless otherwise specified, the term “polypropylene impact copolymer” refers to a semi-crystalline polypropylene or polypropylene copolymer matrix containing a heterophasic copolymer. The heterophasic copolymer includes ethylene and higher alpha-olefin polymer such as amorphous ethylene-propylene copolymer, for example.

One or more silane compounds are grafted to the polyolefin in the presence of a multifunctional monomer and a radical initiator to form crosslinkable polyolefin compositions.

The silane compounds generally include any unsaturated silane. For example, suitable unsaturated silanes include vinylsilanes, vinylsilane derivatives and combinations thereof. Vinylsilane, also referred to as ethenyl silane, has a chemical structure of CH₂═CH—SiH₃. In one embodiment, the vinylsilane derivative is a vinyl alkoxysilane compound having a general chemical structure of CH₂═CH—Si(OR)₃, wherein R is any alkyl group of 1 to 4 carbons. Examples of vinyl alkoxysilane compounds include vinyltrimethoxysilane, vinyltriethoxysilane, vinylmethoxyethoxysilane and combinations thereof, for example.

In one or more embodiments, the multifunctional monomers generally include difunctional monomers, trifunctional monomers and combinations thereof, for example. Suitable multifunctional monomers include acrylic monomers. The acrylic monomers may include 2-(2-ethoxyethoxy) ethyl acrylate, diethylene glycol diacrylate, tridecyl acrylate, tridecylacrylate hexanediol diacrylate, lauryl acrylate, alkoxylated lauryl acrylate, caprolactone acrylate, 1,6-hexanediol diacrylate, trimethylolpropane triacrylate, polyethylene glycol diacrylate, neopentane diol diacrylate, polyethylene glycol diacrylate and combinations thereof, for example.

In one or more embodiments, the multifunctional monomers may be hydrophobic or hydrophilic. As used herein, the term “hydrophilic” refers to multifunctional monomers having oxygen or nitrogen atoms in their backbone structure. For example, the hydrophilic multifunctional monomers may include 2-(2-ethoxyethoxy) ethyl acrylate, tetrahydrofufuryl acrylate, polyethylene glycol (200) diacrylate, tetraethylene glycol diacrylate, triethylene glycol diacrylate, tripropylene glycol diacrylate, polyethylene glycol (400) diacrylate or combinations thereof.

The radical initiator may include any free radical initiator known to one skilled in the art. Suitable radical initiators include organic peroxides, azo-containing compounds, azide compounds and the like and combinations thereof, for example. For example, the radical initiator may be a commercially available peroxide such as TRIGANOX® 301 (commercially available from Akzo-Nobel Chemicals, Inc.) or LUPERSOL® 101 (n-butylperoxy neodecanoate), for example.

In one or more embodiments, contacting of the above-mentioned components may generally occur by blending the polyolefin, multifunctional monomer, silane compound, and radical initiator components in a single step process. The blending may occur by introducing the polyolefin, multifunctional monomer, silane compound, and radical initiator components into a system capable of combining the components to graft copolymerize the silane compound and multifunctional monomer onto the polyolefin. For example, the blending may be accomplished by introducing the polyolefin (e.g., polypropylene), multifunctional monomer, and silane compound into a batch mixer, continuous mixer, single screw extruder or twin screw extruder, for example, to form a homogeneous mixture or solution, introducing a free radical initiator and providing pressure and temperature conditions so as to graft copolymerize the multifunctional monomer and silane compound onto the polyolefin.

During blending, the silane compound may be present in a concentration of from about 0.1 wt. % to about 20 or from about 0.5 wt. % to about 15 wt. %. or from about 1 wt. % to about 10 wt. %, based on the weight of polyolefin charged to the system, for example. Similarly, during blending, the multifunctional monomer may be present in a concentration of from about 0.1 wt. % to about 20 wt. %, or from about 0.5 wt. % to about 1.5 wt. %, or from about 1 wt. % to about 10 wt. %, based on the weight of polyolefin charged to the system, for example.

In one example, reactive extrusion may be employed to graft copolymerize the multifunctional monomer and silane compound, onto the polyolefin. The polyolefin, multifunctional monomer, silane compound, and radical initiator components are introduced into an extruder which provides intimate contact between the components introduced therein as well as pressure and temperature conditions to permit graft copolymerization of the silane and multifunctional monomer onto the polyolefin.

The multifunctional monomer may participate in the grafting reaction to bridge the silane compound to the polyolefin. During grafting, a first functional group of the multifunctional monomer reacts with the polyolefin and the first and second functional groups of the multifunctional monomer can react with the silane compound, thereby boosting silane grafting yield to the polyolefin. The polymerization of the multifunctional monomer with the polyolefin and silane compound occurs readily as a result of the radical initiator forming free radicals at the functional groups of the multifunctional monomer. Thus, the grafting reaction includes a first free radical reaction between a free radical at the first functional group of the multifunctional monomer and a radical, site along the polyolefin chain and a second free radical reaction between a free radical at the second functional group of the multifunctional monomer and an unsaturated group (e.g., the vinyl group) of the silane compound.

Advantageously, the radical initiator acting upon the multifunctional monomer results in a substantially lower occurrence of polyolefin chain scission. During grafting, free radical reactions at the reactive functional groups of the multifunctional monomer effectively suppress radical attack and main chain scission of the polyolefin. Thus, the resulting crosslinkable silane-grafted polyolefin composition has a substantially higher molecular weight and a lower melt flow rate, as compared to a cross linkable silane-grafted, polyolefin composition formed by free-radical grafting of silane compounds in the absence of the multifunctional monomer.

### Product Application

The resulting crosslinkable polyolefin compositions are useful in applications known to one skilled in the art, both alone or as masterbatches. Typical applications include forming operations such as film, sheet, pipe and fiber extrusion and co-extrusion as well as blow molding, injection molding and rotary molding. Films include blown, oriented or cast films formed by extrusion or co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include slit-films, monofilaments, melt spinning, solution spinning and melt blown fiber operations for use in woven or non-woven form to make sacks, bags, rope, twine, carpet backing, carpet yarns, filters, diaper fabrics, medical garments and geotextiles, for example. Extruded articles include medical tubing, wire and cable coatings, sheets, such as thermoformed sheets (including profiles and plastic corrugated cardboard), geomembranes and pond liners, for example. Molded articles include single and multi-layered constructions in the form of bottles, tanks, large hollow articles, rigid food containers and toys, for example.

Crosslinkable articles may be formed and subsequently crosslinked to form crosslinked polyolefin articles. Moisture initiated crosslinking may be accomplished by any method known to one of ordinary skill in the art. In accordance with one method, the resulting cross-linkable article may be crosslinked in a high humidity environment at a slightly elevated temperature over a period of several hours to several days and weeks. In another method, a crosslinking catalyst may also be utilized to accelerate the crosslinking of polyolefin article. The catalyst may be added to the crosslinkable silane-grafted polyolefin composition prior to forming the composition into the desired cross-linkable article. Upon exposure to moisture, both the moisture and the catalyst cause the silane groups to react together to form a crosslink between the polyolefin chains.

In particular, the crosslinkable polyolefin compositions formed herein and blends therefore can be used to form a wide variety of crosslinked materials and crosslinked articles that exhibit improved mechanical and chemical properties such as increased creep resistance, mechanical strength, chemical resistance, abrasion resistance, and/or wear resistance. The improved mechanical and chemical properties are principally a consequence of the higher molecular weight crosslinkable polyolefin having a higher degree of silane grafting per polyolefin chain. Upon silane crosslinking, the resulting silane crosslinked material/article is more extensively crosslinked and, consequently, possesses the many superior mechanical and chemical properties previously mentioned.

In one or more embodiments, the crosslinkable polyolefin compositions formed herein and blends thereof are advantageously utilized to form crosslinked articles requiring superior creep and/or wear resistance. Exemplary crosslinked articles generally include pipe articles, cable jacketing, and wire insulation. For example, pipe articles may include pipe, tubing, molded fittings, pipe coatings, and combinations thereof. The pipe articles which exhibit superior creep and wear resistance may be advantageously utilized in industrial/chemical processes, mining operations, gas distribution, potable water distribution, gas and oil production, fiber optic conduit, sewer systems and pipe relining, for example.

In another embodiment, the crosslinkable polyolefin compositions formed herein and blends thereof are advantageously utilised as coupling agents in fabricating polyolefin-glass composites (e.g., polyolefin-glass fibers, polyolefin-glass beads, etc.) to enhance the adhesion between the glass component and the polyolefin component of the composite as well as increase the durability of the composite. In particular, the silane groups of the crosslinkable polyolefin composition provide stable bonds between the inorganic glass component (e.g., glass fiber) and the polyolefin. In one example, silane groups, of a crosslinkable polypropylene composition formed in accordance with the present invention is utilized to form stable bonds between a glass fiber and the polypropylene component of the crosslinkable polypropylene composition. As a result of the crosslinkable polypropylene composition having a higher molecular weight and higher degree of silane grafting, the glass fiber's polypropylene coating exhibits superior adhesion and durability.

In another embodiment, the crosslinkable polyolefin compositions formed herein and blends thereof can be introduced with long chain branching by moisture treatment of slightly silane grafted polyolefins. Minimal vis-breaking plus long-chain branching result in desired high melt strength, which exhibit superior benefits especially for thermoforming, pipe, foaming, sheet extrusion thermoforming, etc. applications where high melt strength is critical.

### EXAMPLES

### Example 1

Five samples were produced based on Total Petrochemicals 3371, SILFIN® 25, TRIGANOX® 301, and a number of different multifunctional monomers. The multifunctional monomers included SR259 polyethylene glycol (200) diacrylate. SR230 diethylene glycol diacrylate, and SR454 ethoxylated trimethylopropane triacrylate, respectively, commercially available from Cray Valley Corp. The first sample was based on 3371, SILFIN® 25 (vinyl trimethoxylsilane supplied by Evonik), and peroxide TRIGANOX® 301. The second, third and fourth samples were similar to the first sample but with different multifunctional monomers in their original compositions. To compare the silane grafting efficiency, all the formulations including the control possessed the same ratio of SILFIN® 25 over PP base resin in their original compositions. The grafting reactions were conducted on a 27 mm co-rotation twin-screw extruder. The PP pellets were fed into the main hopper. All the liquid feedstock were pre-mixed and injected into the PP melt inside the extruder downstream. The unreacted monomers and volatiles were removed by vacuum devolatilization before the melt exited the die.

TABLE 1

| Samples | Compositions | MFR (g/10 min) | FTIR 775/2723 cm-1 |
|---|---|---|---|
| 1 | 3371 + 1.5% <Silfin 25 + 4% Tri-301> | 43.8 | 0.280 |
| 2 | 3371 + 1.97% <Silfin 25 + 20% SR259 + 4% Tri-301> | 15.7 | 0.118 |
| 3 | 3371 + 1.97% <Silfin 25 + 20% SR230 + 4% Tri-301> | 18.5 | 0.196 |
| 4 | 3371 + 1.97% <Silfin 25 + 20% SR454 + 4% Tri-301> | 19.1 | 0.251 |

The products were vacuum dried and then measured for melt flow rates (MFRs). Presence of multifunctional monomers significantly lowered the product MFRs, indicating that vis-breaking of PP was greatly minimized. FTIR was also used to characterize the products. Typically, absorption at 775 cm-1 corresponded to that of methoxylsilane, and the absorption at 2723 cm-1 resulted from polypropylene. Thus, the ratio of 775 cm-1 over 2723 cm-1 was used to represent the silane grafting yield of the materials. All the formulations containing multifunctional monomers showed reasonably high grafting yields. Generally, melt grafting of vinylsilane onto PP resulted in extensive PP vis-breaking, which essentially compromised the desired performance of melt strength or ability to crosslinking. It was expected that multi-functional monomers were not only able to stabilize polypropylene macro-radicals, minimizing vis-breaking, but also acted as coupling agent, increasing polypropylene molecular weight. The multi-functional monomers might also be able to boost the silane grafting efficiencies by generating more active sites for silane grafting reactions. MFR and FTIR results indicated that the multifunctional monomer SR454, a more hydrophilic triacrylate, was able to achieve similar silane grafting yield to the control (w/o multifunctional monomer) with significantly minimized PP vis-breaking.

### Example 2

The samples in Example 1 were further blended with a crosslinking catalyst masterbatch containing, dioctyltin dilaurate, and then were treated in a water bath at 80° C. for a week. Thus, samples 1 through 4 in the above Example became sample X-1 through X-4, accordingly. Upon treatment, the melt flow rates were lowered significantly, indicating formation of crosslinking and long chain branching. The materials containing multifunctional monomers in their original compositions showed much higher zero shear viscosity, and hence higher melt strengths.

TABLE 2

| | X-1 | X-2 | X-3 | X-4 |
|---|---|---|---|---|
| MFR before treatment | 43.6 | 15.7 | 18.5 | 19.1 |
| (g/10 min) | | | | |
| MFR after treatment | 18.7 | 9.1 | 8.6 | 9.4 |
| (g/10 min) | | | | |
| Zero Shear Viscosity | 698 | 1480 | 1569 | 1459 |
| (Pa · s) | | | | |
| Relaxation Time (s) | 0.0097 | 0.0218 | 0.0211 | 0.021 |
| Breadth Parameter | 0.4817 | 0.4989 | 0.4617 | 0.479 |
| Power Law Slope Factor | 0.2 | 0.2 | 0.2 | 0.2 |
| Predicted Melt Flow | 22.64 | 10.59 | 10.72 | 11.28 |
| Predicted Mw | 194086 | 246512 | 246804 | 244385 |
| Predicted Mn | 44589 | 50952 | 51198 | 49653 |
| Predicted Mz | 616436 | 805607 | 853347 | 833815 |
| Predicted MWD | 4.4 | 4.8 | 4.8 | 4.9 |
| Temperature (° C.) | 230 | 230 | 230 | 230 |

While the foregoing is directed to embodiments of the present invention, other and further embodiments of the invention may be devised without departing from the basic scope thereof and the scope thereof is determined by the claims that follow.

What is claimed is:

1. A process for forming a crosslinkable silane-grafted polypropylene composition comprising:
contacting a polyolefin, a multifunctional monomer and a silane compound in the presence of a radical initiator, wherein the polyolefin is selected from polypropylene, polyethylene, combinations thereof and copolymers thereof.

2. The process of claim 1, wherein the polyolefin is selected from polypropylene homopolymer, polypropylene based random copolymer, and polypropylene impact copolymer.

3. The process of claim 1, wherein the multifunctional monomer is selected from difunctional monomers, trifunctional monomers and combinations thereof.

4. The process of claim 3, wherein the multifunctional monomer is either hydrophobic or hydrophilic.

5. The process of claim 3, wherein the multifunctional monomer is an acrylic monomer.

6. The process of claim 1, wherein the multifunctional monomer is selected from diethylene glycol diacrylate, tridecylacrylate hexanediol diacrylate, 1,6-hexanediol diacrylate, trimethylolpropane triacrylate, polyethylene glycol diacrylate, neopentane diol diacrylate, polyethylene glycol diacrylate, tetraethylene glycol diacrylate, tripropylene glycol diacrylate, diethylene glycol diacrylate, ethoxylated trimethylolpropane triacrylate, trimethylopropane triacrylate (TMPTA) esters, propoxylated neopentyl glycol diacrylate, alkoxylated hexanediol diacrylate, tris (2-hydroxy ethyl) isocyanurate triacrylate, and combinations thereof.

7. The process of claim 1, wherein the multifunctional monomer contacts the polyolefin in a concentration of from about 0.1 wt. % to about 20 wt. %.

8. The process of claim 1, wherein the silane compound is vinylsilane, a vinylsilane derivative, or a combination thereof.

9. The process of claim 1, wherein the silane compound is a vinyl alkoxysilane compound having a general chemical structure of CH₂═CH—Si(OR)₃, wherein R is any alkyl group of 1 to 4 carbons.

10. The process of claim 1, wherein the silane compound is selected from vinyltrimethoxysilane, vinyltriethoxysilane, vinylmethoxyethoxysilane, and combinations thereof.

11. The process of claim 1, wherein the silane compound contacts the polyolefin in a concentration of from about 0.1 wt. % to about 20 wt. %.

12. The process of claim 1, wherein the radical initiator is a peroxide.

13. The process of claim 1, wherein the contacting comprises blending the polyolefin, the multifunctional monomer, the silane compound, and the radical initiator in a single step.

14. The process of claim 1, wherein the crosslinkable silane-grafted polyolefin composition is capable of forming a crosslinked or long-chain branched product by forming the composition into an article and exposing the article to moisture.

15. The process of claim 1, wherein the crosslinkable silane-grafted polyolefin composition is a coupling agent capable of adhering to glass.

16. A crosslinkable silane-grafted polyolefin composition formed by the process of claim 1.
